(19) United States
(12) Patent Application Publication
(10) Pub. No.: US 2003/0199292 A1
(43) Pub. Date: Oct. 23, 2003

(54) Digital versatile disc containing game

(76) Inventor: Barry P. Greenberg, Huntington Valley, PA (US)

Correspondence Address: COZEN AND O'CONNOR, 1900 MARKET STREET, PHILADELPHIA, PA, 19103, US

(21) Appl. No.: 10/124,448

(22) Filed: Apr. 17, 2002

(51) Int. Cl. G06F 17/00

(52) U.S. Cl. 463/1

(57) ABSTRACT

A method of advertising using a DVD includes providing an advertisement, such as a commercial, including various clues on the DVD. The commercial is displayed from the DVD. Various clues are displayed before, during or after the commercial. A viewer responds after finding the various clues in the commercial. The viewer's responses associated with the commercial are received. Then, it is determined if those responses meet predetermined conditions, such as timeliness and accuracy. A game play, such as an instant-win game, is provided if the responses meet those predetermined conditions. The instant-win game has one of a winning outcome and a losing outcome. A prize, such as a monetary prize, is awarded based upon the winning outcome of the game card. Otherwise, a digital work, such as a music video, is displayed from the DVD based upon the losing outcome.

### BACKGROUND OF THE INVENTION

1. Field of the Invention

The present invention relates to DVDs and, more particularly, to DVDs providing game plays, prizes, advertisements and/or displays of digital works. The invention also relates to a method of using a DVD and, more particularly, to using a DVD in connection with game plays, prizes, advertisements, distribution and/or displays of digital works.

2. Background Information

A DVD is a high-capacity optical disk format or an optical disk using such a format. A DVD contains one or more digital works, such as, for example, an audio and/or video recording, such as a movie, or computer data.

In recent years, DVDs (Digital Video Discs; Digital Video Disks; Digital Versatile Discs) have increasingly been used as high-capacity recording mediums. The DVD format provides many capabilities and functions exceeding those provided by, for example, the VHS format. For example, the DVD format combines the audio-visual capability of the VCR with the digital retrieval capacity of the computer. DVDs also provide improvements in storage capacity, picture and sound, digital capability for immediate retrieval and interactivity, and the capacity for specialized coding and programming.

The DVD is a random access optical disc similar in physical dimensions to a CD, but with substantially more data storage capacity. A wide range of DVD sizes and storage capacities are possible. As non-limiting examples, a “DVD 5” can store up to 4.7 Gbytes on a single side, a “DVD 9” can store up to 9 Gbytes on a single side with two layers, and a “DVD 18” can store up to 18 Gbytes on two sides with two layers. Also, a small mini disc can hold up to 2 Gbytes on one side with two layers.

A DVD can store, for example, one full-length motion picture in one of two layers on either side of the disc. Many DVDs include subtitles and/or closed captioning in a plurality of languages for a motion picture as stored on the DVD, multiple camera angles for a scene, and the capability to play one of a plurality of different content versions (e.g., a director's cut; an unrated version; an “R” rated version). A DVD records data called a system stream, which is created using MPEG2 (Moving Picture Experts Group 2) video-compression techniques. A video stream, an audio stream, and a sub-picture stream are interleaved into the system stream.

Devices capable of playing DVDs provide, for example, capabilities for fast-forward, fast rewind, slow motion, frame by frame, skip to the main menu, skip to the title menu, skip-forward to the beginning of the next chapter, skip-backward to the beginning of the current chapter, skip-backward to the beginning of the previous chapter, turn on/off subtitles, selecting the language of the subtitle, selecting the language of the audio, selecting camera angles, and multiple content versions.

There is room for improvement in DVDs and DVD methods.

### SUMMARY OF THE INVENTION

These and other needs are met by the present invention which provides a game play, prize, advertisement and/or conditional display of a digital work in association with a DVD.

As one aspect of the invention, a DVD comprises a game play including a predetermined outcome, which awards a prize; and a DVD medium bearing the game play.

As another aspect of the invention, a DVD comprises a first digital work; a second digital work including one of a first outcome, which awards a prize, and a second outcome, which does not award the prize; and a DVD medium bearing the first digital work and the second digital work.

As another aspect of the invention, a DVD comprises a first digital work; a second digital work; a third digital work including one of a first outcome, which awards a prize, and a second outcome, which does not award the prize; and a DVD medium bearing the first digital work, the second digital work, and the third digital work.

The second outcome of the third digital work may display the second digital work.

As another aspect of the invention, a DVD comprises a first digital work; a second digital work, which is separate and distinct from the first digital work, the second digital work including one of a first outcome, which inhibits the first digital work, and a second outcome, which displays the first digital work; and a DVD medium bearing the first digital work, and the second digital work.

The second digital work may be a game play or an advertisement.

As another aspect of the invention, a method of displaying a work from a DVD comprises storing a first digital work on the DVD; storing a second digital work on the DVD; storing a game play, which is separate and distinct from the second digital work, on the DVD; employing the game play having one of a first outcome and a second outcome; and selectively displaying the second digital work based upon the first outcome of the game play and, otherwise, inhibiting display of the second digital work.

As another aspect of the invention, a method of awarding a prize with a DVD comprises storing a first digital work on the DVD; storing a second digital work on the DVD; storing a game play on the DVD; employing the game play having one of a first outcome and a second outcome; and selectively awarding a prize based upon the first outcome of the game play, and displaying the second digital work based upon the second outcome of the game play.

As another aspect of the invention, a method of awarding a prize with a DVD comprises storing a digital work on the DVD; storing a game play having a predetermined outcome on the DVD; and awarding a prize based upon the predetermined outcome of the game play.

The method may comprise storing a commercial associated with the game play on the DVD; displaying the commercial; receiving input during the step of displaying the commercial; and providing the game play responsive to the input.

The method may comprise employing a first digital work as the digital work on the DVD; storing a second digital work on the DVD; employing the game play having one of a first outcome and a second outcome; and selectively awarding the prize based upon the first outcome of the game play and displaying the second digital work based upon the second outcome of the game play.

As another aspect of the invention, a method of advertising using a DVD comprises providing an advertisement including at least one clue on the DVD; displaying the advertisement and the at least one clue; receiving at least one response; determining if the at least one response meets a predetermined condition; providing a game play if the at least one response meets the predetermined condition; employing the game play having one of a first outcome and a second outcome; and selectively awarding a prize based upon the first outcome of the game play and displaying a digital work based upon the second outcome of the game play.

The method may comprise employing a commercial as the advertisement; employing a plurality of clues as the at least one clue; and employing a plurality of codes corresponding to the clues.

The method may comprise employing a digital work on the DVD; receiving the codes; initiating the game play in response to the codes; and providing access to the digital work on the DVD in response to the second outcome of the game play. At least one of the clues may be provided from a source external to the DVD.

As another aspect of the invention, a method of advertising using at least one advertisement and a DVD comprises displaying the at least one advertisement; associating at least one code with the at least one advertisement; receiving the at least one code; determining if the at least one code matches at least one predetermined code and responsively providing a game play on the DVD; and awarding a prize or displaying a digital work from the DVD based upon the game play.

The method may comprise employing a commercial as the at least one advertisement; initiating the game play in response to the at least one code; and awarding the prize in response to the game play.

The method may comprise employing a plurality of codes as the at least one code; initiating the game play in response to the at least one code; and displaying an information screen related to the prize.

The method may comprise employing a commercial as the at least one advertisement; employing a digital work on the DVD; receiving the at least one code; initiating the game play in response to the at least one code; and providing access to the digital work on the DVD in response to the game play.

The method may comprise renting the DVD; and providing an Internet web site to access the at least one code.

As another aspect of the invention, a method of distributing a DVD comprises employing a DVD with a first digital work and a second digital work; distributing the DVD; displaying the first digital work; employing instructions to purchase the second digital work; receiving a payment for the second digital work; sending a code to access the second digital work in response to the payment; receiving the code to access the second digital work; and displaying the second digital work responsive to the code.

As another aspect of the invention, a method of awarding a prize with a DVD comprises storing a digital work on the DVD; storing a first game play on the DVD; employing the first game play having one of a first outcome and a second outcome; and selectively awarding a prize based upon the first outcome of the first game play, and providing a second game play based upon the second outcome of the first game play.

As another aspect of the invention, a method of advertising using a DVD comprises providing an advertisement including at least one clue on the DVD; displaying the advertisement; displaying the at least one clue; receiving at least one response associated with the advertisement; determining if the at least one response meets a predetermined condition; providing a game play if the at least one response meets the predetermined condition; employing the game play having one of a first outcome and a second outcome; and awarding a prize based upon the first outcome of the game play or displaying a digital work based upon the second outcome of the game play.

As another aspect of the invention, a method of advertising using a DVD comprises providing an advertisement on the DVD; displaying the advertisement; displaying at least one question after the step of displaying the advertisement; receiving at least one response to the at least one question; determining if the at least one response is correct; providing a game play if the at least one response is correct; employing the game play having one of a first outcome and a second outcome; and awarding a prize based upon the first outcome of the game play or displaying a digital work based upon the second outcome of the game play.

### BRIEF DESCRIPTION OF THE DRAWINGS

A full understanding of the invention can be gained from the following description of the preferred embodiments when read in conjunction with the accompanying drawings in which:

FIG. 1 is a flow chart showing a method of displaying a work from a DVD in accordance with the present invention.

FIG. 2 is a flow chart showing a method of awarding a prize with a DVD and displaying a work from the DVD in accordance with another embodiment of the present invention.

FIG. 3 is a flow chart showing another method of awarding a prize with a DVD in accordance with another embodiment of the present invention.

FIG. 4 is a flow chart showing a method of advertising with the DVD of FIG. 3.

FIG. 5 is a flow chart showing a method for advertising using a DVD in accordance with another embodiment of the present invention.

FIG. 6 is a block diagram showing another method for advertising using a DVD in accordance with another embodiment of the present invention.

FIG. 7 is a block diagram showing a method of advertising and awarding a prize with a DVD in accordance with another embodiment of the present invention.

FIG. 8 is a block diagram showing another method of advertising and awarding a prize with a DVD in accordance with another embodiment of the present invention.

FIG. 9 is a block diagram showing a method for advertising using a DVD in accordance with another embodiment of the present invention.

FIG. 10 is a block diagram showing a method for distributing a DVD in accordance with another embodiment of the present invention.

FIG. 11 is a block diagram showing another method of awarding a prize with a DVD in accordance with another embodiment of the present invention.

FIGS. 12-15 are block diagrams of DVDs in accordance with other embodiments of the present invention.

### DESCRIPTION OF THE PREFERRED EMBODIMENTS

As employed herein, the term “person” means a natural person, firm, corporation, other business or non-profit entity, association, group or organization.

As employed herein, the terms “viewer,” “user” and/or “consumer” include persons.

As employed herein, the term “communication network” shall expressly include, but not be limited to, any local area network (LAN), wide area network (WAN), intranet, extranet, global communication network, wireless communication system or network, and the Internet.

As employed herein, the terms “display” and “displaying” shall expressly include, but not be limited to, computer displays for displaying information, such as prize and/or demographic information. It will be appreciated that such information may be stored, printed on hard copy, be computer modified, be combined with other data, or be transmitted for display elsewhere. All such processing shall be deemed to fall within the terms “display” or “displaying” as employed herein.

### EXAMPLE 1

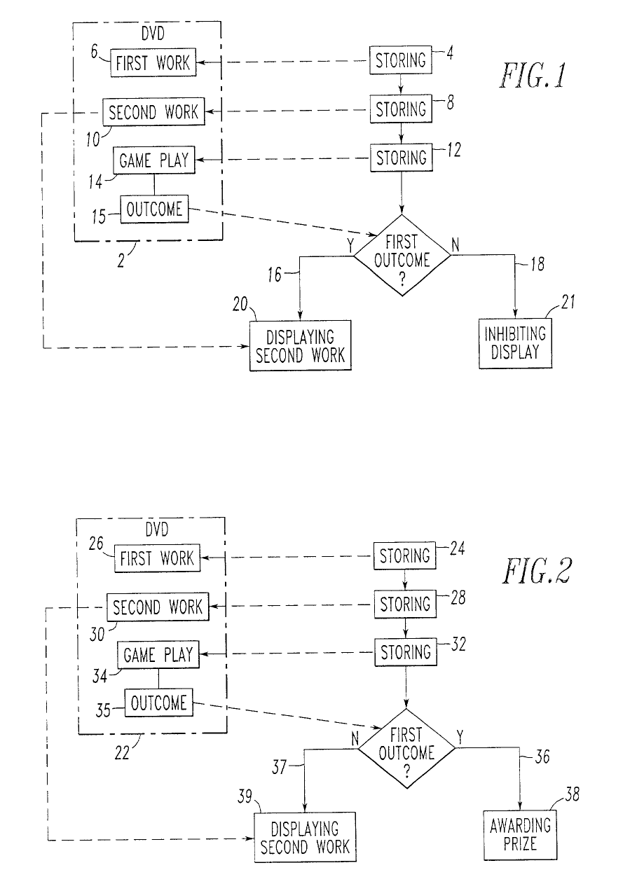

Referring to FIG. 1, a method of displaying a work from a DVD 2 includes the steps of storing, at 4, a first digital work 6 (e.g., without limitation, a movie) on the DVD 2; storing, at 8, a second digital work 10 (e.g., without limitation, a music video) on the DVD 2; storing, at 12, a game play having an outcome 15, which is one of a first outcome 16 (e.g., win) and a second outcome 18 (e.g., lose) on the DVD 2; and selectively displaying, at 20, the second digital work 10 based upon the game play first outcome 16 and, otherwise, inhibiting display, at 21, of the second digital work 10.

### EXAMPLE 2

FIG. 2 shows a method of awarding a prize with a DVD 22 including the steps of storing, at 24, a first digital work 26 on the DVD 22; storing, at 28, a second digital work 30 on the DVD 22; storing, at 32, a game play 34 having an outcome 35, which is one of a first outcome 36 (e.g., win) and a second outcome 37 (e.g., lose) on the DVD 22; and selectively awarding a prize (e.g., without limitation, a cash prize, a good, a service), at 38, based upon the game play first outcome 36 and, otherwise, displaying, at 39, the second digital work 30.

### EXAMPLE 3

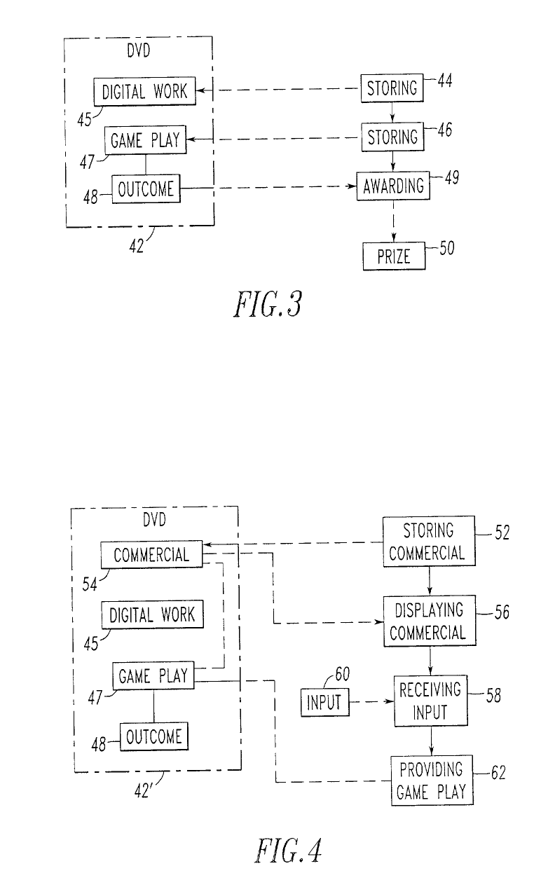

Referring to FIG. 3, a method of awarding a prize with a DVD 42 includes the steps of storing, at 44, a digital work 45 on the DVD 42; storing, at 46, a game play 47 having a predetermined outcome 48 (e.g., win or lose) on the DVD 42; and awarding, at 49, a prize 50 based upon the predetermined outcome 48 of the game play 47. For example, the prize 50 is awarded based upon a winning state of the outcome 48, but not for a losing state of the outcome 48.

### EXAMPLE 4

Although FIG. 1 (Example 1) employs, for example, a game play 14, the game plays disclosed herein, including, but not limited to, the games plays 14, 34, 47, may be any of a wide range of game plays, such as, for example, any instant or contemporaneous game that awards a prize or reveals a prize winning notification, a click and win a match and win, a spin and win, a slot machine, and an instant-win. As other examples, an instant-win game play may be in the form of a spin and win, or other random play, that is activated by a person, such as a user or viewer, via a click and play game on any suitable display device (e.g., a television, an entertainment center, a personal computer (PC)). Further examples of suitable games for game plays are disclosed in U.S. Pat. No. 5,007,641, which is incorporated by reference herein.

As a few specific examples of game plays, there are wheel games, dice games, card games, and “pop the balloon” games. In a wheel game, such as spin and win, the user clicks “enter” on the DVD remote and a representation of a wheel spins and lands on a winning or losing space. In another wheel game, such as a slot machine, the user clicks enter on the DVD remote and a representation of a slot machine spins and pays off prizes in the event, for example, that three of a kind are displayed.

In a dice game, the user clicks enter on the DVD remote and a representation of dice is “rolled”. If, for example, there are three matching dice, then there is a winner.

In a card game, including, for example, a representation of five cards, a user clicks on a card and the corresponding card representation “turns over”, thereby exposing the specific type of card. If the user exposes all five cards and there are, for example, four of a kind, then this is a winning outcome.

In a pop the balloon game, there is a representation of, for example, nine balloons. The user clicks on a balloon representation, in order to cause it to “pop” and expose a prize. If the user exposes all nine balloons and, for example, three prizes match, then there is a winner.

### EXAMPLE 5

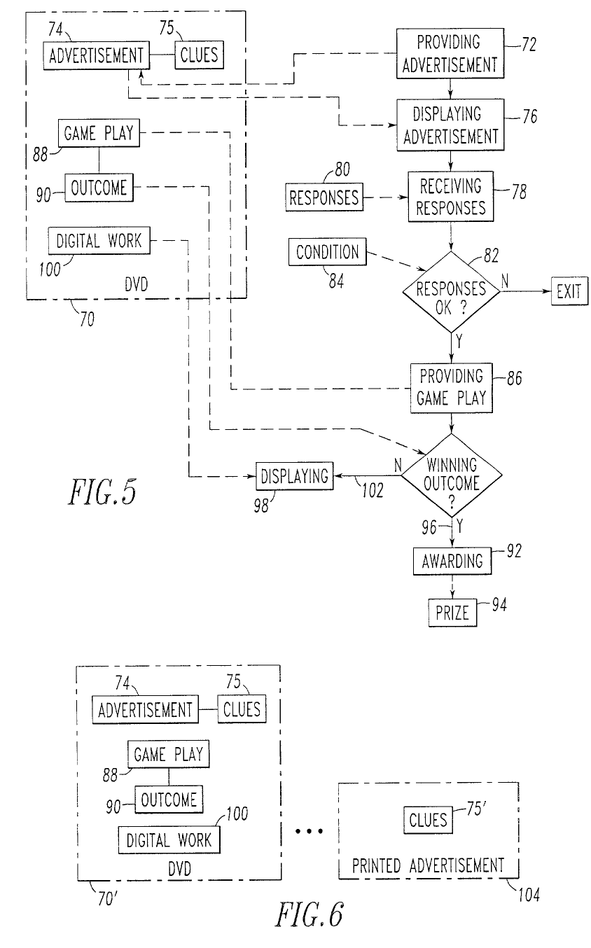

As shown in FIG. 4, the method of FIG. 3 (Example 3) may be used in association with the DVD 42′, which is similar to the DVD 42. In this example, the method further includes storing, at 52, a digital commercial 54 associated with the game play 47 on the DVD 42′; displaying, at 56, the commercial 54; receiving, at 58, input 60 during the display of the commercial 54; and providing, at 62, the game play 47 responsive to the input 60. For example, the commercial 54 may include a clue (not shown) (e.g., which suggests that a user or viewer should enter the input 60 responsive to the clue) or a prompt (not shown) (e.g., which informs a user or viewer to enter the input 60 responsive to the prompt), in order to motivate the user or viewer to watch a portion, and preferably at least a significant portion, of the commercial 54 prior to the time that the game play 47 is provided.

### EXAMPLE 6

Similar to the method of FIG. 2 (Example 2), one or more digital works may be stored on the DVD 42 of FIG. 3 or the DVD 42′ of FIG. 4. For example, one digital work may be a movie and another digital work may be a music video. The game play 47 may have a winning outcome and a “losing” outcome. Based upon those outcomes, the prize 50 is awarded based upon the winning outcome as discussed above in connection with FIG. 3. On the other hand, the music video is displayed based upon the “losing” outcome (e.g., in a similar manner as discussed above in connection with FIG. 2). This provides, for example, further motivation for the user or viewer to watch a portion, and preferably at least a significant portion, of the commercial 54 prior to the time that the game play 47 is provided, since such user or viewer can either: (1) be awarded the prize 50; or (2) can watch the music video.

### EXAMPLE 7

Similar to the method of Example 6, the other digital work may be any suitable specialized video content (e.g., a popular video) contained within the DVDs 42,42′ that the user or viewer can access by watching the commercial 54. For example, by providing proper input (e.g., timely input 60 responsive to the clue or prompt), the game play 47 is provided. In the event of the “losing” outcome of the game play 47, one or more of several actions may be taken. For example: (1) the specialized video content is displayed; (2) a menu is displayed instructing the non-winner of the prize 50 to click on an icon to gain access to the specialized video content; and/or (3) a menu is displayed including codes and instructions for the non-winner of the prize 50 to enter the codes to gain access to the specialized video content.

In the third option, the user or viewer may remember the codes and use the same to gain access to the specialized video content at a later time. Otherwise, there is no way to access the specialized video content without these codes since the content area of the DVDs 42,42′ is locked to the user or viewer. For example, a software script (not shown) is inserted into the DVDs 42,42′, in order to block access to the specialized video content without the correct combination of codes.

### EXAMPLE 8

Referring to FIG. 5, a method of advertising using a DVD 70 includes providing, at 72, an advertisement 74 including one or more clues 75 on the DVD 70; displaying, at 76, the advertisement 74 including the one or more clues 75; receiving, at 78, one or more responses 80; determining, at 82, if the responses 80 meet a predetermined condition 84; providing, at 86, a game play 88 from the DVD 70 having a predetermined outcome 90; and selectively awarding, at 92, a prize 94 based upon a first outcome 96 (e.g., winning) of the game play 88 and displaying, at 98, a digital work 100 from the DVD 70 based upon a second outcome 102 (e.g., losing) of the game play 88. Although the exemplary game play has the predetermined outcome 90, the invention is applicable to a wide range of outcomes (e.g., based upon chance, such as provided by a random number generator).

### EXAMPLE 9

As a more particular example of FIG. 5, with the purchase, rental or other acquisition (e.g., as a gift, as a promotional item) of the DVD 70, a user, viewer or consumer may choose to watch one or more particular advertisements 74 (e.g., a commercial, other designated content on the DVD 70, a trailer advertisement to a movie on the DVD 70, a promotion) in order to gain access to the game play 88 and, thus, the chance to win the prize 94 (e.g., a cash prize, a good, a service). The viewer watches the one or more advertisements 74 and finds the graphical clues 75 therein.

Preferably, the graphical clues 75 are relatively easy to find and are positioned to motivate the viewer to watch at least a significant portion, if not all, of the advertisement 74 prior to the time that the game play 88 is provided. The viewer can watch the advertisement 74 one or more times, in order to obtain the graphical clues 75. Once the viewer sees one of the graphical clues 75 (e.g., without limitation, a person drinking a beverage, a person wearing yellow riding a bicycle, stars and stripes), they have to respond within a predetermined period of time (e.g., by hitting an “enter” button on a DVD controller within a specified time frame). If the response is timely, then the game play 88 is provided.

### EXAMPLE 10

Although FIG. 5 (Example 8) shows selectively awarding the prize 94 based upon the winning outcome 96 of the game play 88 and displaying the digital work 100 from the DVD 70 based upon the losing outcome 102 of the game play 88, the invention is applicable to DVDs which contain: (1) an advertisement providing a method of accessing a game play; and/or (2) specialized video content, which can be accessed by watching an advertisement and: (a) displaying the specialized video content, (b) displaying instructions for the viewer to display the specialized video content, and/or (c) displaying a code or codes and instructions for the viewer to enter such code(s) to display the specialized video content.

For example, the digital work 100 (e.g., a popular video) may be displayed to non-winners of the prize 94, the viewer may be instructed to click on an icon to gain access to the digital work 100, and/or codes may be displayed along with instructions for the viewer to enter such code(s) to display the digital work 100. Otherwise, in this example, there is no way to access the digital work 100 without these codes since the content area of the DVD 70 is locked to the user or viewer. For example, a software script (not shown) is inserted into the DVD 70, in order to block access to the digital work 100 without the correct code(s).

### EXAMPLE 11

As more particular examples of FIG. 5 (Example 8), the advertisements 74 may be: (1) a single advertisement having a single graphical clue 75; (2) a single advertisement having two or more graphical clues 75; (3) two or more advertisements each of which has a single graphical clue 75; and (4) two or more advertisements each of which has one or more graphical clues 75.

Preferably, the DVD 70 provides a specialized interactive display in which the viewer views one or more commercials or other designated content and identifies one or more specific graphical clues contained therein. These graphical clues are predetermined and are provided to the viewer prior to the display of, or at about the start of, the commercials.

### EXAMPLE 12

As further more particular examples of FIG. 5 (Example 8), after the one or more responses 80 meet the predetermined condition 84, the game play 88 may be provided: (1) after entry of the one or more responses 80; (2) after entry of the one or more responses 80 and after display of a screen instructing the viewer of a successful response; (3) after entry of the one or more responses 80 and during the display of the advertisement 74; (4) after entry of the one or more responses 80 and after the display of the advertisement 74; or (5) after entry of the one or more responses 80, after display of a screen instructing the viewer of one or more security codes, and after entry of such one or more security codes.

### EXAMPLE 13

As further more particular examples of FIG. 5 (Example 8), the viewer may provide the response(s) 80 from: (1) a DVD controller; (2) a mouse, keyboard or other suitable input device of a DVD compatible device, such as a PC; or (3) another suitable DVD input device. For example, the viewer may be instructed to click on the “enter” button on the DVD remote control each time the viewer identifies a clue (e.g., a person wearing red) in a commercial.

### EXAMPLE 14

In the event that plural responses 80 are employed in steps 78,80,82 of FIG. 5, then it is determined if one of the responses 80 met the predetermined condition 84 and was received, for example, within a predetermined time (e.g., about 2 seconds, any suitable time) after displaying a corresponding one of the graphical clues 75. For any subsequent one or more responses 80: (1) the same advertisement 74 may be re-displayed; (2) display of the same advertisement 74 may be continued; or (3) another one of the advertisements 74 may be displayed. Next, it is determined if the subsequent response 80 met the predetermined condition 84 and was received, for example, within the predetermined time after displaying the corresponding one of the graphical clues 75. This process continues until the final one of the advertisement(s) 74 is displayed and, thus, it is determined if all of the plural responses 80 met the predetermined condition 84.

### EXAMPLE 15

In the event that security codes are employed for plural responses 80 of step 82 of FIG. 5, then one or more security codes may be provided to the viewer if the corresponding one of the responses 80 was received, for example, within the predetermined time. For example, if the viewer clicks the DVD controller “enter” button within a specified time (e.g., 2 seconds) after the corresponding graphical clue 75 is displayed, then a display provides the corresponding security code(s) to the viewer before displaying any remaining advertisement(s) 74 to look for any corresponding remaining graphical clues 75.

### EXAMPLE 16

As a more particular example for Example 15, the viewer may employ all of the security codes to initiate the game play 88 in response to such codes. In this manner, if the viewer is successful in identifying all the security codes, then the viewer can initiate the game play 88 by entering such codes in order to determine if the viewer is to be awarded the prize 94 and/or if the digital work 100 is to be displayed based upon the game play outcome 90.

### EXAMPLE 17

As a more particular example for Example 16, the viewer may initially employ all of the security codes to initiate the game play 88 in response to such codes. Then, for the “losing” outcome 102 of the game play 88, the user is provided access to the digital work 100 on the DVD 70. That access may be provided by: (1) displaying the digital work 100; (2) permitting the viewer to enter the security codes to display the digital work 100; or (3) displaying the same codes and/or another code or codes along with instructions for the viewer to enter such code(s) to display the digital work 100.

For example, the digital work 100 (e.g., a popular video) may be displayed to non-winners of the prize 94, the viewer may be instructed to click on an icon to gain access to the digital work 100, and/or codes may be displayed along with instructions for the viewer to enter such code(s) to display the digital work 100.

### EXAMPLE 18

The digital work 100 from the DVD 70 of FIG. 5 may include, for example, any digital work, such as specialized media content, a video, a music video (e.g., sponsored by a music company), an interview, an exclusive interview (e.g., with a major personality), at least one photograph, or a set of still pictures (e.g., of a popular personality). In this manner, for example, if the viewer is not a winner of the prize 94, the viewer is still given access to specific content of the digital work 100 on the DVD 70. Preferably, in this example, the digital work 100 of the DVD 70 is separate and distinct from (e.g., independently created) the other digital content (not shown) of the DVD 70, such as, for example, a movie.

### EXAMPLE 19

The DVDs disclosed herein may be purchased, rented or otherwise acquired (e.g., as a gift, as a promotional item). A wide range of DVD styles, contents and sizes may be employed. For example, the DVD 70 of FIG. 5 may have a conventional size or may be a miniature DVD.

### EXAMPLE 20

The DVDs disclosed herein may be miniature DVDs, which may be promotional items that are provided in combination with the sale of a beverage contained in a cup having a plastic cup top, which delivers such miniature DVD. See, for example, U.S. Pat. No. 6,302,288, which discloses a hinged closure configured for mounting to a conventional drink cup container, such as the type commonly employed in quick service restaurants, and for enclosing a digital media disk, such as a CD-ROM, therein.

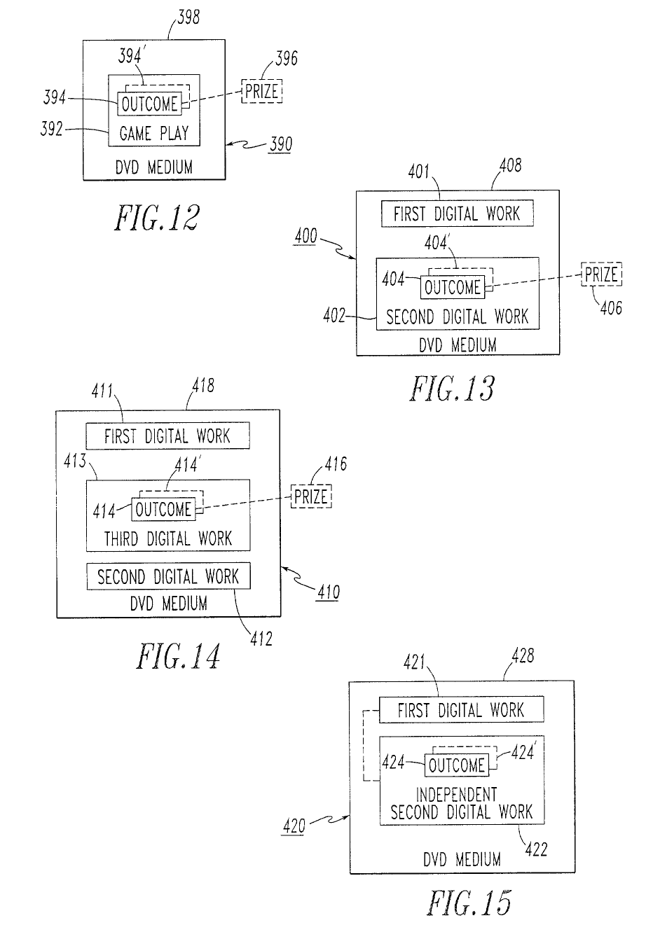

In this manner, as part of the promotion, the consumer may receive, for example, the game play 392 of FIG. 12; the game play 47 and the digital work 45 (e.g., a music video) of FIG. 3; the game play 47, digital work 45 (e.g., a music video) and commercial 54 of FIG. 4; and/or the game play 88, digital work 100 (e.g., a music video) and advertisement 74 of FIG. 5.

### EXAMPLE 21

As an alternative to FIG. 5, FIG. 6 shows a DVD 70′, which is similar to the DVD 70, except that one, some or all of one or more clues 75′ are provided from a source, such as printed advertisement 104, which is external to the DVD 70′.

### EXAMPLE 22

As an alternative to Example 21, the source 104 external to the DVD 70′ may be any suitable source, such as, for example, an Internet advertisement, an advertisement at a retail store, any printed advertisement (e.g., in a magazine, newspaper, periodical), any audio advertisement (e.g., a standard broadcast media commercial; a special one-time commercial, such as a commercial during the Super Bowl), any video advertisement (e.g., a standard broadcast media commercial; a special one-time commercial, such as a commercial during the Super Bowl), an insert with a good (or package for the good), or a handout or other advertisement associated with a service.

### EXAMPLE 23

As an alternative to Example 21, in the event that security codes are employed for plural responses 80 of step 82 of FIG. 5, then one, some or all of such codes may be provided from a source, such as printed advertisement, which is external to the DVD 70′.

### EXAMPLE 24

As an alternative to Example 23, the source 104 external to the DVD 70′ may be any suitable source, such as, for example, the sources discussed above in connection with Example 22.

### EXAMPLE 25

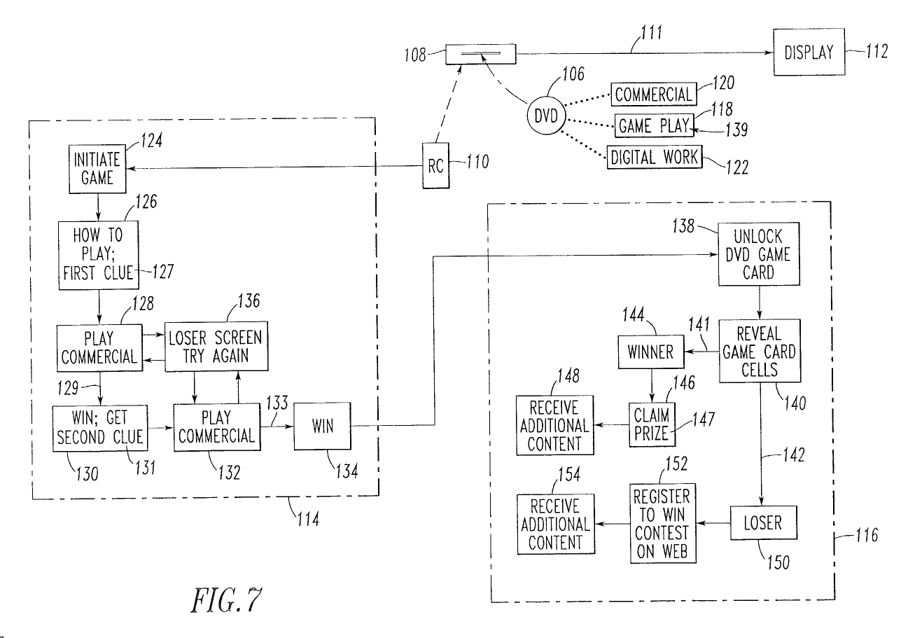

Referring to FIG. 7, a DVD 106 is used in combination with a conventional DVD player 108 (e.g., a suitably equipped computer or PC, television, entertainment center, or other suitable DVD playing device) having a conventional controller, such as remote control (RC) 110. Although the RC 110 is shown, any other suitable input device (not shown), such as buttons or controls on the DVD player 108, a mouse, a keyboard, or any suitable user or viewer input device, may be employed. In turn, as is well-known, the DVD player 108 sends video output to a suitable display 112 (e.g., of a television, entertainment center, or PC) and/or audio output (not shown) to a suitable speaker (not shown) associated with the display 112. The DVD 106 may be similar to the DVDs 2, 22 or 42 of FIGS. 1, 2 or 3, respectively. FIG. 7 also shows the flow of steps associated with initiating and accessing, at 114, and playing, at 116, a game play 118, such as one of the game plays 14, 34 or 47 of FIGS. 1, 2 or 3, respectively.

In the exemplary embodiment, step 114 initiates and accesses the game play 118 by finding two exemplary clues 127,131 in a commercial 120. In this embodiment, both the game play 118 and the commercial 120 are stored on the DVD 106. Step 114 commences after the DVD 106 is inserted in the DVD player 108 and after an initial screen (not shown) is displayed on the display 112. Step 116 plays the game play 118 and selectively awards a prize 147 for the winning outcome 141 of the game play 118 or, alternatively, displays the digital work 122 (e.g., a music video) from the DVD 106 for the losing outcome 142 of the game play 118.

First, at 124, the viewer initiates the game play 118, for example, by employing the remote control (RC) 110 to select a suitable icon (not shown) on the initial DVD display screen (not shown). Next, at 126, another screen (not shown) is displayed including instructions for playing the game play 118 and the first clue 127 (e.g., find a person dressed in yellow riding a bicycle in the commercial 120). Then, at 128, the commercial 120 is displayed. If the viewer finds, at 129, the first clue 127 (e.g., by pressing “enter” on the RC 110 within a suitable time after that clue is displayed), then, at 130, a winning screen (not shown) is displayed along with the second clue 131 (e.g., find the “stars and stripes” in the commercial 120). Then, at 132, the commercial 120 is re-displayed. If the viewer finds, at 133, the second clue 131 (e.g., by pressing “enter” on the RC 110 within a suitable time after that clue is displayed), then, at 134, a winning screen (not shown) is displayed.

Although the exemplary embodiment re-displays the same commercial 120, a different commercial (not shown) may be displayed. Also, although two clues 127,131 in two displays of the same commercial 120 are employed, one clue in the display of one commercial, plural clues in the display of one commercial, or one or more clues in the display of plural commercials may be employed.

On the other hand, if the viewer did not properly find the first clue 127, at 128, or the second clue 131, at 132, then, at 136, a losing screen (not shown) is displayed and the commercial 120 is re-displayed at 128.

After the viewer has properly found the two clues 127,131, and after 134, at 138, a DVD game card 139 of the game play 118 is unlocked. Preferably, for ease of access to the game card 139 by the viewer, the game play 118 automatically transitions from step 134 to step 138. Alternatively, as discussed above in connection with Examples 12, 15-17 and 23, the viewer may enter security codes (not shown) in order to unlock the game card 139.

Next, at 140, the DVD game card 139 is displayed Any one or more of the game plays set forth in Example 4 may be employed. In the event of the winning outcome 141, a winning screen (not shown) is displayed at 144. Next, at 146, instructions (not shown) for the viewer to claim the prize 147 are displayed. Then, at 148, the digital work 122 may be displayed.

On the other hand, in the event of the losing outcome 142, a losing screen (not shown) is displayed at 150. Next, at 152, instructions (not shown) for the viewer to register to possibly win a contest on the Internet are displayed. Then, at 154, the digital work 122 is displayed.

### EXAMPLE 26

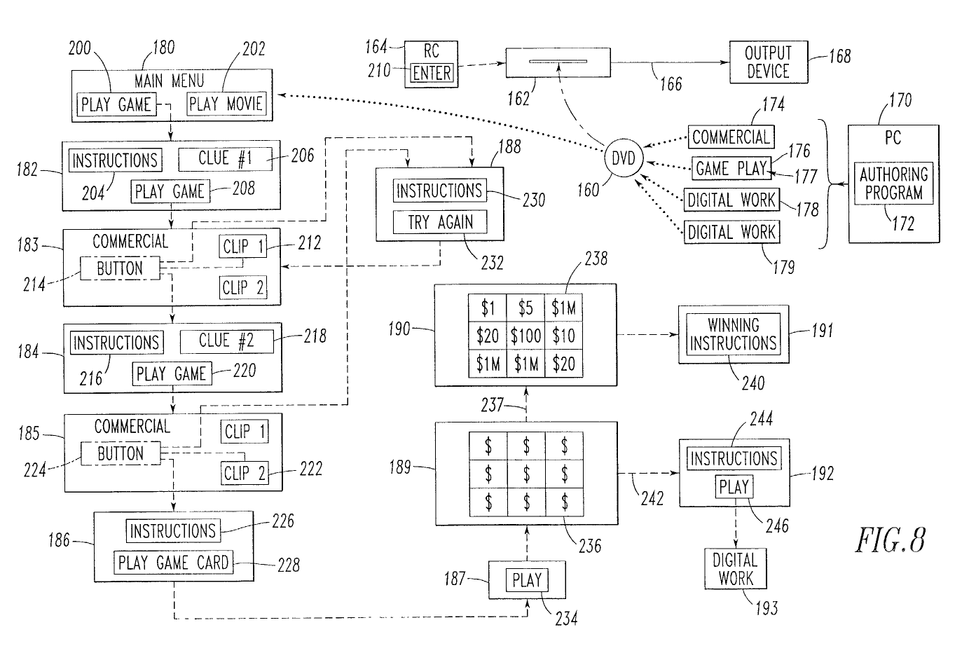

Similar to FIG. 7, FIG. 8 shows a DVD 160 used in combination with a conventional DVD player 162 having a conventional controller, such as remote control (RC) 164. In turn, as is well-known, the DVD player 162 sends video and/or audio output 166 to a suitable output device 168 (e.g., a television, entertainment center, or PC). In addition, FIG. 8 shows a personal computer (PC) 170 including a suitable authoring program 172 for creating the DVD 160 having a commercial 174, game play 176, game card 177, and one or more digital works 178,179 stored thereon.

The authoring program 172 employed to create the interactivity of the exemplary DVD instant-win game card 177 is DVD Studio Pro marketed by Apple Computer of Cupertino, Calif. DVD Studio Pro authors DVDs (e.g., Digital Video Discs; Digital Video Disks; Digital Versatile Discs) and functions with pre-existing audio, video, graphics and/or text materials on, or accessibly by, the PC 170. DVD Studio Pro orchestrates such materials into a DVD, such as 160, that can be played on a DVD player, such as 162. Although the exemplary authoring program 172 is disclosed, any suitable software or program may be employed to store digital works (e.g., digital materials) on a DVD, such as, for example, the Sonic Solutions Creator program or the SONIC DVD CREATOR® computer software marketed by Sonic Solutions of Novato, Calif.

Associated with the game play 176, commercial 174 and digital works 178,179 on the DVD 160 are a series of menu displays 180 and 182-193. The main menu 180 for the DVD 160 has two buttons 200,202. The first button 200 is employed by the viewer, through the remote control 164, to commence the promotion. For example, the button 200 says “play the instant-win game” or “win $1,000,000.00 instantly”. As is conventional, the button 202 is employed by the viewer (again, through the exemplary remote control (RC) 164) (for simplicity of disclosure, it will be understood that subsequent menu buttons may be employed by the viewer through the RC 164 or any other suitable control) to play a digital work, such as the digital work 179 (e.g., a movie).

Menus, such as 180, are added through the authoring program 172. The buttons on an individual menu (e.g., 180) are linked during the authoring process with program 172 to specify which buttons (e.g., 200,202) become active when the user presses each of the various keys (e.g., “enter” 210) on the remote control 164. In this manner, the main menu of the digital work 179 (e.g., a Hollywood movie) is upgraded with a new button, such as 200, that displays a suitable graphic (e.g., “play game” or “Play Million Dollar Madness”). In turn, using suitable authoring procedures, a new graphic and overlay are added to the main menu. When the user or viewer advances to this button (e.g., 202, or 200) and activates it, the script (not shown) created by the authoring program 172 jumps the viewer to a video (e.g., work 179 in response to button 202) or another menu (e.g., 182 in response to button 200) on how to play the game.

When the user selects the button 200, the next menu 182 is displayed. This menu 182 displays instructions 204 for the viewer to initiate the game play 176, a first clue 206, and a button 208 that says “play game”.

When the user selects the button 208, the commercial 174 is displayed, at 183, until: (1) the viewer clicks a button 210 (e.g., “enter”) on the DVD player controller 164 during the time that a specific portion or first clip 212 (e.g., a portion of the commercial 174 during which a person dressed in yellow rides a bicycle) of the commercial 174 is displayed, which clip 212 contains video and/or audio related to the first clue 206 (e.g., find a person dressed in yellow riding a bicycle in the commercial 174); or (2) the complete commercial 174 is displayed. The first commercial clip 212 includes an invisible or non-displayed button 214.

The authoring program 172 allows the programmer to create a “hot area” that is placed over a moving video, such as commercial 174, where the user can click with their remote 164. If the hot area is still present, then it will skip them to a new menu (e.g., 184,186) or video. Usually, there is a graphical overlay, in order that the viewer can see where they are on the screen. However, with the invisible button (e.g., 214,224) there is no graphical overlay. Hence, the viewer cannot see where the invisible button is or if there is one at all. When the user hits, for example, the “enter” button 210 on the remote control 164 and the invisible button or hot area (e.g., 214,224) is still on the screen, then the display jumps to a corresponding new menu screen (e.g., 184,186) or video that indicates that they were correct and have found the corresponding clue.

When the user selects this invisible or non-displayed button 214 (e.g., by clicking the DVD player controller “enter” button 210 during or about the time (e.g., without limitation, a suitable period of time during and/or after the clip 212; a suitable period of time prior to and/or during and/or after the clip 212; about 1.5 to 3.0 seconds in length) that the invisible button 214 is “displayed”), the next menu 184 is displayed.

The menu 184 displays instructions 216 (e.g., “you've found the first clue”), a second clue 218, and a button 220 that says “play game”.

When the user selects the button 220, the commercial 174 is re-displayed, at 185, until: (1) the viewer clicks the button 210 on the DVD player controller 164 during the time that a specific portion or second clip 222 (e.g., a portion of the commercial 174 showing a flag including stars and stripes) of the commercial 174 is displayed, which clip 222 contains video and/or audio related to the second clue 218 (e.g., find the stars and stripes in the commercial 174); or (2) the complete commercial 174 is displayed. The second commercial clip 222 includes an invisible or non-displayed button 224.

When the user selects this invisible or non-displayed button 224 (e.g., by clicking the DVD player controller “enter” button 210 during or about the time (e.g., without limitation, a suitable period of time during and/or after the clip 222; a suitable period of time prior to and/or during and/or after the clip 222; about 1.5 to 3.0 seconds in length) that the invisible button 224 is “displayed”), the next menu 186 is displayed.

The new menu 186 displays instructions 226, which instructions inform the viewer that they found the second clue 218 and can move to the next menu 187 by clicking on a button 228 that says “play game card”.

Otherwise, during the display of the commercial 174 at 183 or 185, if the viewer clicks the DVD controller “enter” button 210 at the wrong time (e.g., when the invisible buttons 214 or 224 are not displayed) or, else, not at all, then after the commercial 174 is displayed, another menu 188 is displayed.

The menu 188 displays instructions 230 (e.g., “please try again”) and a button 232 that says “try again”. When the user selects this button 232, the commercial 174 is re-played, at 183, thereby, giving the viewer a second chance to click the “enter” button 210 at the proper times.

Otherwise, in response to the “play game card” button 228, the menu 187 is displayed including a “play” button 234, which lets the viewer reveal the game card 177. Although menu 187 and button 234 are shown, these may be eliminated such that in response to the “play game card” button 228, the menu 189 is displayed.

In this example, when the user selects the button 234, the menu 189 is displayed. This menu 189 displays a representation 236 of the game card 177. In the exemplary embodiment, the representation 236 includes nine boxes, each of which has a Dollar (“$”) sign therein. During the display of the representation 236, for purpose of viewer suspense and entertainment, each of the Dollar signs is removed, one after the other, to reveal various different monetary values “behind” each of the Dollar signs. In turn, for the winning outcome 237, as shown in menu 190, all of the Dollar signs are removed to reveal whether one or more matches are present. For purpose of this example, if three boxes match (e.g., three boxes show “$1M” or “$1,000,000.00”), then the representation 238 of the revealed game card 177 is a winning DVD game card and the next menu 191 is displayed. The menu 191 displays instructions 240 for the viewer to claim the winning prize.

Otherwise, for the losing outcome 242, if after the game card representation 236 reveals all nine boxes having (in this example) less than three matching boxes, then another menu 192 is displayed. The menu 192 displays instructions 244 for the viewer to, for example: (1) have another chance to play for a prize on the Internet; and/or (2) view, at 246, the digital work 178 (e.g., a music video) on the DVD 160. In this example, this display is only available to the viewer by going through the above process of finding the clues 206,218 in the commercial 174.

Regardless, the promotion on the DVD 160 forces the viewer to watch the commercial 174 as the only way to access the game play 176, the alternative chance to play for a prize on the Internet, and/or the additional content of the digital work 178 on the DVD 160, which features are only available to the viewer by going through the above process of finding the clues 206,218.

### EXAMPLE 27

As a more specific example for Example 26, a specific feature is preferably employed in the authoring program 172. During the display of the commercial 174 from the DVD 160 at 183 and/or 185, the DVD 160 is pre-programmed to accept, for example, only certain buttons from the RC 164 (e.g., the “enter” button 210 and a “stop” button (not shown)), in order to disable or otherwise lock the viewer out of using any of the other DVD player controller buttons. By doing this, the viewer cannot, for example, fast forward or rewind the commercial 174. This feature forces the viewer to watch the commercial 174 in real time as the only way to find the clues 206,218 during the respective clips 212,222 and access the game card 177.

The authoring program 172 enables the programmer to allow the user to employ all controls on the remote 164 while watching, for example, the commercial 174 and/or one of the commercial clips 212,222, or to deny the user use of some or all controls on such remote while watching a particular commercial, clip or track. For example, if the programmer denies use of controls for the commercial 174, then the viewer cannot use the fast forward, fast rewind, next button, back button, menu button, title button, angle button, return button, slow motion button, or still button. The only buttons that will work are the stop and enter buttons on the remote 164.

### EXAMPLE 28

As a more specific example for Example 26, the commercial 174 may -be an advertising commercial, which provides one or more security codes in order to access the game play 177 (e.g., an Instant-Win). For example, three security codes (e.g., the three numbers “1,” “2,” and “3”; the three numbers “4,” “2,” and “3”; any suitable codes) may be employed, with one security code being provided with the instructions 216 after the first clue 206 is located, and two security codes being provided with the instructions 226 after the second clue 218 is located.

For example, the menu 187 may be replaced by a series of seven menus (not shown) during which: (1) the viewer enters the first security code (e.g., the number “1”; the number “4”; any suitable code) on a first keypad and selects an “enter” button; (2) a menu is displayed showing that “the selection was accepted”; (3) the viewer enters the second security code (e.g., the number “2”; any suitable code) on a second keypad and selects an “enter” button; (4) a menu is displayed showing that “the selection was accepted”; (5) the viewer enters the third security code (e.g., the number “3”; any suitable code) on a third keypad and selects an “enter” button; (6) a menu is displayed showing that “the selection was accepted”; and (7) a menu is displayed that either states “congratulations, the three codes were correctly entered” if all three security codes were properly entered, or provides instructions to inform the viewer that the codes are incorrect and that they have one more chance to enter the codes correctly. In turn, if the codes are again entered incorrectly, then the DVD player 162 ejects the DVD 160 and displays its initial display (not shown) on the associated output device 168.

### EXAMPLE 29

As an alternative to the DVD 160, the prize and the game card 177 of Example 26, another DVD (not shown) may provide the viewer with the opportunity to play the clue game at steps 180,182,183,184,185 of FIG. 8, in order to access the digital work 178 (e.g., a music video). Hence, the instant game card 177, or any other suitable game play, need not be present on the DVD since this feature may be at the discretion of the particular promotion. In that event, the menus 186,187,189,190,191, 192 are simply removed from, or are not installed on, the DVD, and the digital work 178 is displayed after the second clue 218 is properly found at 185.

### EXAMPLE 30

As a more specific example for Example 29, after the second clue 218 is properly found, at 185, and before the digital work 178 is displayed, the user or viewer is provided with one or more security codes in order to access that digital work. In this manner, the user or viewer need not watch the commercial 174 for a second time, in order to gain access to the digital work 178. The security code(s) may be entered in any suitable fashion (e.g., as discussed above in connection with Example 28). For example, the initial DVD display (not shown) may include three or more buttons in order to: (1) play the digital work 179 (e.g., a movie); (2) initiate the game play 176, in order to gain access to the security codes; and (3) display a menu (not shown) for entry of the security codes, in order to play the digital work 178 (e.g., a music video).

### EXAMPLE 31

Referring to FIG. 9, a method of advertising using one or more advertisements (AD) 250,251 (e.g., without limitation, a commercial or other promotion, a printed advertisement, an Internet advertisement, a video advertisement, an audio advertisement, an advertisement at a retail store, an advertisement on a DVD) and a DVD 252 is shown. The method includes displaying, at 254, the one or more advertisements 250,251, and associating, at 256, one or more security codes (SC) 258 with the one or more advertisements 250,251. In a preferred embodiment, one or more of the advertisements 250 are on media external to the DVD 252. In this manner, the method of identifying clues from the DVD 252 (e.g., steps 180,182,183,184,185 of FIG. 8 for DVD 160) may be supplemented by external advertisements 250 for goods and/or services, which are the same as, or different from, the goods and/or services covered by the advertisement 251 (e.g., the DVD commercial 174 of FIG. 8).

In turn, a person collects the one or more security codes 258, which are received by a DVD script 259, at 260. Then, at 262, it is determined if those one or more security codes 258 match one or more corresponding predetermined codes (PRED CODES) 264 on the DVD 252. If so, then a game play 266 on the DVD 252 is responsively initiated at 268. In the preferred embodiment, based upon the outcome of the game play 266, a prize 269 is awarded at 270 (e.g., as discussed above in connection with FIG. 8, winning instructions related to the prize 269, such as instructions 240, may be displayed on an information screen from the DVD 252) for the winning outcome 272, and a digital work 273 (e.g., a music video) is displayed from the DVD 252, at 274, for the losing outcome 276. In this manner, if the viewer is not a winner of a prize, such as 269, the viewer is given access to specific content on the DVD 252. Hence, the promotion may state that “everyone wins”.

### EXAMPLE 32

As a more specific example for Example 31, one of the advertisements 250 may be a printed advertisement 280 (e.g., in a newspaper or periodical) for a good and/or service. Included with the printed advertisement 280 is text 282, which informs the viewer of a particular code 284 of the security codes 258 for the DVD 252. For example, the text 282 may state “the second security code for the DVD 252 is ‘7’”. In this manner, by employing the cross-platform marketing of Examples 31 and/or 32, the DVD 252 along with the printed advertisement 280 may enhance the performance of that advertisement 280 and/or boost circulation of the corresponding periodical.

### EXAMPLE 33

As another more specific example for Example 31, one of the advertisements 250 may be an Internet advertisement 290 for a good and/or service. This advertisement 290 similarly includes text 292, which informs the viewer of a particular code 294 of the security codes 258 for the DVD 252. For example, the text 292 may state “the third security code for the DVD 252 is ‘1’”. In this manner, by employing the cross-platform marketing of Examples 31 and/or 33, the DVD 252 along with the Internet advertisement 290 may enhance the performance of that advertisement 290 and/or drive Internet traffic to one or more particular web sites (not shown).

### EXAMPLE 34

As another more specific example for Example 31, one of the advertisements 250 may be an advertisement 300 at a retail store 301 for a good and/or service. This advertisement 300 similarly includes text 302, which informs the viewer of a particular code 304 of the security codes 258 for the DVD 252. For example, the text 302 may state “the first security code for the DVD 252 is ‘9’”. In this manner, by employing the cross-platform marketing of Examples 31 and/or 34, the DVD 252 along with the retail store advertisement 300 may enhance the performance of that advertisement 300 and/or drive foot traffic to the particular retail store 301.

### EXAMPLE 35

As another more specific example for Example 31, one or more of the advertisements 280,290,300,310 maybe used in combination with an advertisement 312 on the DVD 252, which advertisement 312 may be similar to the commercial 174 of FIG. 8.

### EXAMPLE 36

Although Example 31 contemplates a music video as the digital work 273, such work 273 may be any suitable digital content such as, for example, supplemental content for a video on a DVD, any specialized media content, a music video sponsored by a music company, an exclusive interview with a major personality, one or more photographs, a set of still pictures of a popular personality, an additional training segment for a training video, or an additional exercise routine for an exercise video.

### EXAMPLE 37

Although a consumer may, most likely, purchase the DVD 252 of FIG. 9, the invention is applicable to DVDs, which are rented. In that instance, the game play 266 on the DVD 252 need not be employed and, instead, a random game play may be provided through an Internet web site (not shown). In turn, that random game play may award a prize for a winning outcome and/or provide security codes to unlock a music video on the DVD for a “losing” outcome.

### EXAMPLE 38

As another more specific example for Example 31, one or more clues 320 to the various external advertisements 250 may be provided in association with the advertisement 312 on the DVD 252. These clues 320 may provide, for example: (1) where to find the various external advertisements 250; (2) when to find the various external advertisements 250; (3) how to extract the codes 258 from the various external advertisements 250; and/or (4) how to find additional clues. As a non-limiting example, one of the clues 320 might state “watch for an advertisement for a car” during a particular television show and “look for the security code on the license plate of that car”. Another one of the clues 320 might state “watch for advertisements during March 2002 for a beverage: these advertisements will provide you with additional clues for obtaining the codes needed to access the game play 266 on DVD 252”. In this manner, by employing the various clues and codes in various different media, the effectiveness of a promotional campaign may be increased.

### EXAMPLE 39

As another more specific example for Example 38, one of the clues 320 may be a final clue that states “watch for a final advertisement during the Super Bowl in order to obtain the final code needed to access the game play 266 on DVD 252”. Although a particular advertisement is disclosed, a wide range of the advertisements 250,251 may be employed as the final advertisement.

### EXAMPLE 40

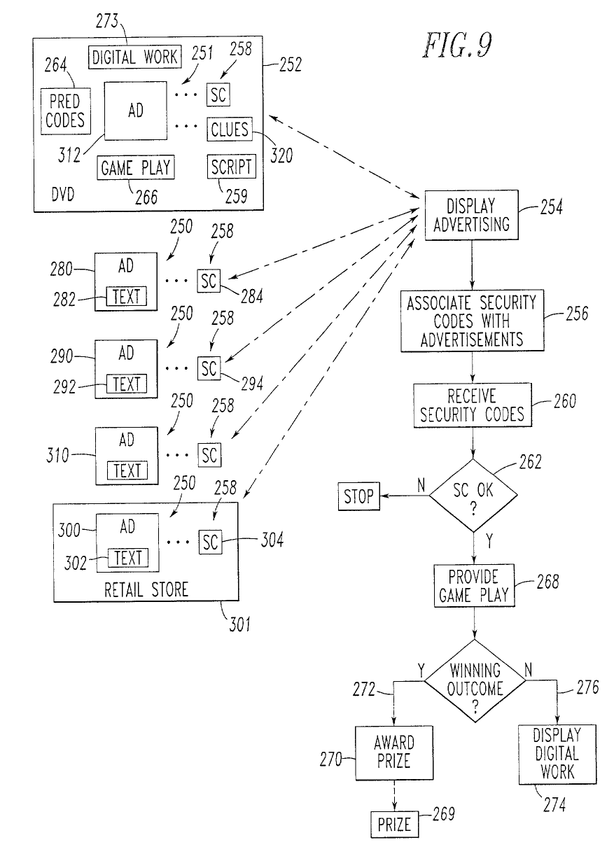

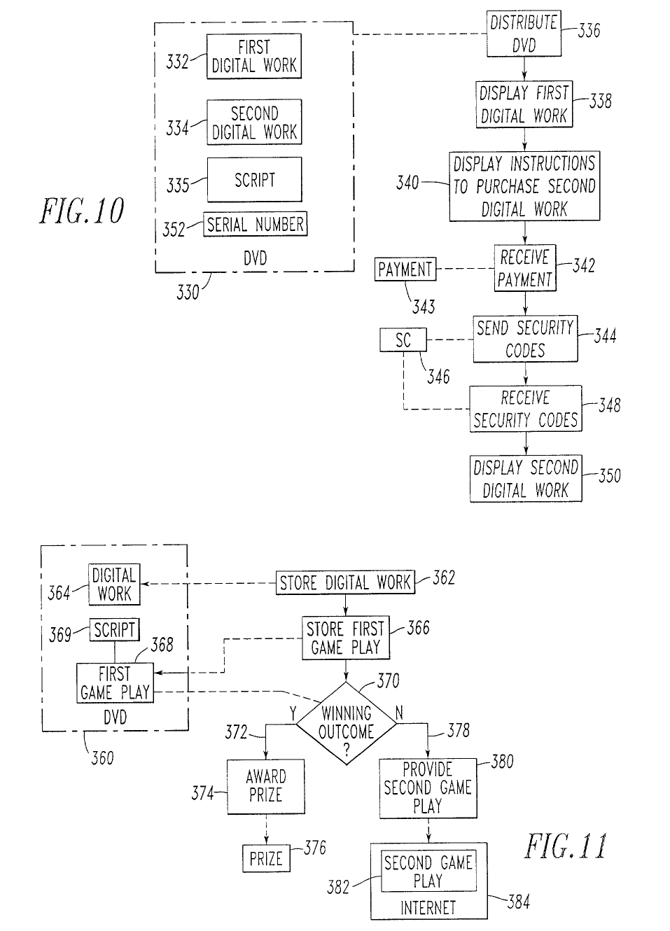

Referring to FIG. 10, a method of distributing a DVD, such as full-content DVD 330 is shown. The DVD 330 has a first digital work 332, a second digital work 334, and a script 335, which pertains to the possible purchase of the second digital work 334. Preferably, the DVD 330 is provided to a prospective consumer: (1) free of charge; (2) as part of a promotion; or (3) for a nominal charge. The DVD script 335 provides ready access to the first digital work 332 (e.g., without limitation, a “teaser” sample or preview of the second digital work 334, such as a movie or an instructional video). The method includes distributing, at 336, the DVD 330; displaying, at 338, the first digital work 332 from the DVD 330; and displaying, at 340, instructions from the script 335 to purchase the second digital work 334. Next, at 342, a payment 343 (e.g., by dialing a “900” telephone number; by accessing a web site; by mailing a check; by employing a credit or debit card to make the payment) is received from the prospective consumer for the second digital work 334. In response, at 344, one or more security codes (SC) 346 are sent to the purchaser, in order to access the second digital work 334. In turn, the DVD script 335 receives, at 348, the codes 346 to access the second digital work 334 and, displays, at 350, the second digital work 334 responsive to the proper codes 346.

For example, the consumer may enter the codes 346 by using the remote control of the DVD player (not shown). Once the consumer obtains and enters the codes 346, the script 335 provides unlimited access to the full DVD content, including the second digital work 334. Preferably, the codes 346 are derived from a unique DVD serial number 352, which is displayed, at 340, along with the script instructions. The prospective consumer provides that particular unique DVD serial number 352 along with the payment 343. In turn, the security codes 346 are provided as a function of the particular unique DVD serial number 352 and, thus, cannot be used to access the full content of a similar DVD that might be sent to another prospective consumer.

This method may be used in combination with one or more advertisements and/or game plays as discussed above in connection with FIGS. 1-9, either before, during or after the payment 343 is made, or before, during or after the codes 346 are provided.

### EXAMPLE 41

FIG. 11 shows a method of awarding a prize with a DVD 360. The method includes storing, at 362, a digital work 364 on the DVD 360, and storing, at 366, a first game play 368 on such DVD. The first game play 368 is driven by a suitable script 369 on the DVD 360, which determines, at 370, whether there is a first (e.g., winning) outcome 372. If so, then, at 374, a prize 376 is selectively awarded based upon the first outcome 372. On the other hand, in the event of a second (e.g., losing) outcome 378, then, at 380, a second game play 382 is provided.

As a preferred practice, the second game play 382 is provided on a global communications network, such as, for example, the Internet 384, which permits the collection of demographic information about the viewer or user in connection with the second game play 382.

### EXAMPLE 42

Referring to FIG. 12, a DVD 390 includes a game play 392 having one of a first predetermined outcome 394, which awards a prize 396, and a second predetermined outcome 394′, which does not award the prize 396. The DVD 390 also includes a suitable DVD medium 398 bearing the game play 392.

### EXAMPLE 43

FIG. 13 shows a DVD 400 including a first digital work 401 and a second digital work 402 having one of a first outcome 404, which awards a prize 406, and a second outcome 404′, which does not award the prize 406. The DVD 400 also includes a suitable DVD medium 408 bearing the first and second digital works 401,402.

### EXAMPLE 44

Referring to FIG. 14, a DVD 410 includes a first digital work 411, a second digital work 412, and a third digital work 413, which has one of a first outcome 414, which awards a prize 416, and a second outcome 414′, which does not award the prize 416. The DVD 400 also includes a suitable DVD medium 418 bearing the first, second and third digital works 411,412,413. Preferably, the second outcome 414′ of the third digital work 413 displays the second digital work 412.

### EXAMPLE 45

FIG. 15 shows a DVD 420 including a first digital work 421 and a second digital work 422, which is separate and distinct from the first digital work 421. The second digital work 422 has one of a first outcome 424, which inhibits the first digital work 421, and a second outcome 424′, which displays the first digital work 421. The DVD 420 also includes a suitable DVD medium 428 bearing the first and second digital works 421,422. In the present example, the second digital work 422 is a game play (e.g., authored by one party), which is separate and distinct from the first digital work 421 (e.g., a movie, authored by a different second party). The first outcome 424 is a “losing” outcome, which inhibits the first digital work 421. The second outcome 424′ is a “winning” outcome, which displays the first digital work 421. Although two digital works 421,422 are shown, the DVD 420 may include additional digital works (not shown).

### EXAMPLE 46

As an alternative to Example 45, the second digital work 422 is an advertisement including a game play.

The DVDs and DVD methods disclosed herein employ unique computer scripts and programming to drive game plays, displays, advertisements and/or promotions. The benefit to the DVD industry is the ability to drive sales of the DVDs through a unique promotional/marketing tool. The benefit to the advertiser is focusing consumer attention while watching an advertisement or promotion on the DVD. The benefit to the user or viewer is the possible prize or other winning outcome from the game play.

### EXAMPLE 47

As an alternative to Example 26, when the user gets to the menu 188 of FIG. 8 that says “try again,” the user is informed that he/she is only looking for the particular clue(s) that was (were) missed.

### EXAMPLE 48

As a more particular example for Example 4, after the user or viewer clicks on the DVD remote (not shown) to play, for example, “Million Dollar Madness”, he/she is informed that after the commercial 54 of FIG. 4 is displayed, a clue will be provided and the user or viewer will be asked to find a particular video clip from the commercial 54. This motivates the user or viewer to closely watch the commercial 54. After the commercial 54 is displayed, a menu is displayed in order to provide the clue and instructions how to click the “enter” button in response to the particular video clip. If the user or viewer clicks the enter button at the proper time during the commercial 54, then access to the game play 47 is provided. On the other hand, if the user or viewer improperly responds, then a menu is displayed after the commercial 54, which menu tells the user or viewer to try again. In turn, when the user or viewer clicks on the enter button to try again, the commercial 54 is displayed in its entirety for a third time before the clue is again provided.

### EXAMPLE 49

As another more particular example for Example 4, after the user or viewer clicks on a DVD remote (not shown) to play, for example, “Million Dollar Madness”, he/she is informed that after the commercial 54 of FIG. 4 is displayed, there will be a trivia question about what the user or viewer has just viewed during the commercial 54. For instance, the question might be: “What color shirt was the boy wearing that was holding the bike? (A) Blue, (B) Green, (C) Yellow, or (D) Red.” If the user or viewer answers the question right, then another question is provided, such as, for example, “Was the boy (A) happy, or (B) sad?” If the user or viewer answers either question wrong, then the commercial 54 is redisplayed in its entirety. Otherwise, if the user or viewer answers both questions correctly, then access to the game play 47 is provided. Although one commercial and two questions are disclosed, one or more commercials and any number of questions (e.g., one, three or more) may be provided.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breath of the claims appended hereto and any and all equivalents thereof.

What is claimed is:

1. A DVD comprising:
a game play including a predetermined outcome, which awards a prize; and
a DVD medium bearing said game play.

2. A DVD comprising:
a plurality of digital works comprising a first digital work and a second digital work;
wherein one of said works includes a first outcome and a second outcome; and
a DVD medium bearing said plurality of digital works.

3. The DVD of claim 2 wherein said first outcome comprises awarding a prize and said second outcome does not comprise awarding said prize.

4. The DVD of claim 3 wherein said works further comprise a third digital work.

5. The DVD of claim 4 wherein said third digital work includes said first outcome and said second outcome, said second outcome comprising displaying said second digital work.

6. The DVD of claim 2 wherein said second digital work is separate and distinct from said first digital work, said second digital work including said first outcome and said second outcome, said first outcome comprising displaying said first digital work and said second outcome comprising inhibiting said first digital work.

7. The DVD of claim 6 wherein said second digital work is a game play or an advertisement.

8. A method of displaying a work from a DVD, said method comprising:
storing a first digital work on said DVD;
storing a second digital work on said DVD;
storing a game play, which is separate and distinct from said second digital work, on said DVD;
employing said game play having one of a first outcome and a second outcome; and
selectively displaying said second digital work based upon the first outcome of said game play and, otherwise, inhibiting display of said second digital work.

9. A method of awarding a prize with a DVD, said method comprising:
storing a first digital work on said DVD;
storing a second digital work on said DVD;
storing a game play on said DVD;
employing said game play having one of a first outcome and a second outcome; and
selectively awarding a prize based upon the first outcome of said game play, and displaying said second digital work based upon the second outcome of said game play.

10. A method of awarding a prize with a DVD, said method comprising:
storing a digital work on said DVD;
storing a game play having a predetermined outcome on said DVD; and
awarding a prize based upon the predetermined outcome of said game play.

11. The method of claim 10 further comprising:
employing as said game play at least one of a click and win, a match and win, a spin and win, a slot machine, and an instant-win.

12. The method of claim 10 further comprising:
storing a commercial associated with said game play on said DVD;
displaying said commercial;
receiving input during said step of displaying said commercial; and
providing said game play responsive to said input.

13. The method of claim 12 further comprising:
employing a first digital work as said digital work on said DVD;
storing a second digital work on said DVD;
employing said game play having one of a first outcome and a second outcome; and
selectively awarding said prize based upon the first outcome of said game play and displaying said second digital work based upon the second outcome of said game play.

14. A method of advertising using a DVD, said method comprising:
providing an advertisement including at least one clue on said DVD;
displaying said advertisement and said at least one clue;
receiving at least one response;
determining if said at least one response meets a predetermined condition;
providing a game play if said at least one response meets said predetermined condition;
employing said game play having one of a first outcome and a second outcome; and
selectively awarding a prize based upon the first outcome of said game play and displaying a digital work based upon the second outcome of said game play.

15. The method of claim 14 further comprising:
employing a commercial as said advertisement;
employing a plurality of clues as said at least one clue; and
employing a plurality of codes corresponding to said clues.

16. The method of claim 15 further comprising:
providing at least one of said clues prior to displaying said commercial.

17. The method of claim 14 further comprising:
receiving said at least one response from a DVD controller.

18. The method of claim 15 further comprising:
employing a plurality of responses as said at least one response;
determining if one of said responses was received within a predetermined time after displaying a corresponding one of said clues; and
providing a corresponding one of said codes if a corresponding one of said responses was within said predetermined time.

19. The method of claim 18 further comprising:
continuing to display said commercial.

20. The method of claim 18 further comprising:
determining if another one of said responses was received within said predetermined time after displaying another corresponding one of said clues; and
providing a corresponding one of said codes if another corresponding one of said responses was within said predetermined time.

21. The method of claim 20 further comprising:
continuing to display said commercial.

22. The method of claim 21 further comprising:
completing display of said commercial.

23. The method of claim 15 further comprising:
receiving said codes;
initiating said game play in response to said codes; and
awarding said prize in response to the first outcome of said game play.

24. The method of claim 14 further comprising:
awarding at least one of money, a good and a service as said prize.

25. The method of claim 24 further comprising:
displaying information related to said prize.

26. The method of claim 15 further comprising:
employing a digital work on said DVD;
receiving said codes;
initiating said game play in response to said codes; and
providing access to said digital work on said DVD in response to the second outcome of said game play.

27. The method of claim 26 further comprising:
employing at least one of a video, and at least one photograph as said digital work.

28. The method of claim 14 further comprising:
employing as said DVD a miniature DVD.

29. The method of claim 15 further comprising:
providing at least one of said clues from a source external to said DVD.

30. The method of claim 29 further comprising:
employing at least one of a printed advertisement, an Internet advertisement, and an advertisement at a retail store as said source external to said DVD.

31. The method of claim 29 further comprising:
employing at least one of a printed advertisement, an audio advertisement, a video advertisement, an Internet advertisement, an advertisement at a retail store, an insert with a product, and a handout with a service as said source external to said DVD.

32. The method of claim 15 further comprising:
providing at least one of said codes from a source external to said DVD.

33. A method of advertising using at least one advertisement and a DVD, said method comprising:
displaying said at least one advertisement;
associating at least one code with said at least one advertisement;
receiving said at least one code;
determining if said at least one code matches at least one predetermined code and responsively providing a game play on said DVD; and
awarding a prize or displaying a digital work from said DVD based upon said game play.

34. The method of claim 33 further comprising:
employing as said at least one advertisement a printed advertisement.

35. The method of claim 33 further comprising:
employing as said at least one advertisement an Internet advertisement.

36. The method of claim 33 further comprising:
employing as said at least one advertisement an advertisement at a retail store.

37. The method of claim 33 further comprising:
employing as said at least one advertisement a plurality of advertisements.

38. The method of claim 37 further comprising:
selecting said advertisements from the list comprising a printed advertisement, an Internet advertisement, a video advertisement, an audio advertisement, and an advertisement at a retail store.

39. The method of claim 33 further comprising:
providing at least one clue for said at least one advertisement.

40. The method of claim 39 further comprising:
displaying said at least one clue.

41. The method of claim 33 further comprising:
displaying at least one clue for said at least one advertisement from said DVD.

42. The method of claim 33 further comprising:
employing a commercial as said at least one advertisement;
initiating said game play in response to said at least one code; and
awarding said prize in response to said game play.

43. The method of claim 33 further comprising:
employing a plurality of codes as said at least one code;
initiating said game play in response to said codes; and
awarding said prize in response to said game play.

44. The method of claim 33 further comprising:
employing a commercial as said at least one advertisement;
employing a digital work on said DVD;
receiving said at least one code;
initiating said game play in response to said at least one code; and
providing access to said digital work on said DVD in response to said game play.

45. The method of claim 44 further comprising:
employing at least one of a video; and at least one photograph as said digital work.

46. The method of claim 33 further comprising:
employing a plurality of codes as said at least one code;
employing a plurality of advertisements as said at least one advertisement; and
providing a plurality of clues to said codes in said advertisements.

47. The method of claim 46 further comprising:
providing a final clue as one of said plurality of clues;
providing a final code as one of said plurality of codes; and
displaying a final advertisement including said final clue and said final code.

48. The method of claim 47 further comprising:
receiving said codes;
initiating said game play in response to said codes; and
awarding said prize in response to said game play.

49. The method of claim 47 further comprising:
employing one of a printed advertisement, an Internet advertisement, a video advertisement, an audio advertisement, and an advertisement at a retail store as said final advertisement.

50. The method of claim 33 further comprising:
renting said DVD; and
providing an Internet web site to access said at least one code.

51. A method of distributing a DVD, said method comprising:
employing a DVD with a first digital work and a second digital work;
distributing said DVD;
displaying said first digital work;
employing instructions to purchase said second digital work;
receiving a payment for said second digital work;
sending a code to access said second digital work in response to said payment;
receiving the code to access said second digital work; and
displaying said second digital work responsive to said code.

52. The method of claim 51 further comprising:
displaying an advertisement before receiving said code.

53. The method of claim 51 further comprising:
displaying an advertisement after receiving said code.

54. The method of claim 51 further comprising:
employing a game play before receiving said code.

55. The method of claim 51 further comprising:
employing a game play after receiving said code.

56. The method of claim 51 further comprising:
dialing a “900” telephone number to make said payment.

57. The method of claim 51 further comprising:
accessing a web site to make said payment.

58. The method of claim 57 further comprising:
paying by credit card to make said payment.

59. The method of claim 51 further comprising:
employing an instructional video as said second digital work.

60. The method of claim 51 further comprising:
employing a movie as said second digital work.

61. The method of claim 60 further comprising:
employing a preview of said movie as said first digital work.

62. A method of awarding a prize with a DVD, said method comprising:
storing a digital work on said DVD;
storing a first game play on said DVD;
employing said first game play having one of a first outcome and a second outcome; and
selectively awarding a prize based upon the first outcome of said first game play, and providing a second game play based upon the second outcome of said first game play.

63. The method of claim 62 further comprising:
providing said second game play on a communications network.

64. The method of claim 63 further comprising:
employing the Internet as said communications network.

65. The method of claim 63 further comprising:
collecting demographic information in connection with said step of providing said second game play on said communications network.

66. A method of advertising using a DVD, said method comprising:
providing an advertisement including at least one clue on said DVD;
displaying said advertisement;
displaying said at least one clue;
receiving at least one response associated with said advertisement;
determining if said at least one response meets a predetermined condition;
providing a game play if said at least one response meets said predetermined condition;
employing said game play having one of a first outcome and a second outcome; and
awarding a prize based upon the first outcome of said game play or displaying a digital work based upon the second outcome of said game play.

67. The method of claim 66 further comprising:
displaying said at least one clue before displaying said advertisement.

68. The method of claim 66 further comprising:
displaying said at least one clue after displaying said advertisement;
redisplaying said advertisement; and
receiving said at least one response during said step of redisplaying.

69. A method of advertising using a DVD, said method comprising:
providing an advertisement on said DVD;
displaying said advertisement;
displaying at least one question after said step of displaying said advertisement;
receiving at least one response to said at least one question;
determining if said at least one response is correct;
providing a game play if said at least one response is correct;
employing said game play having one of a first outcome and a second outcome; and
awarding a prize based upon the first outcome of said game play or displaying a digital work based upon the second outcome of said game play.

70. The method of claim 69 further comprising:
employing a commercial as said advertisement; and
employing at least one of said at least one question associated with said commercial.
